(19) United States
(12) Patent Application Publication
(10) Pub. No.: US 2008/0275719 A1
(43) Pub. Date: Nov. 6, 2008

(54) Trust-based Rating System

(75) Inventors: John Stannard Davis, Corte Madera, CA (US); Eric Moe, Mill Valley, CA (US)

Correspondence Address: STEFAN KIRCHANSKI, VENABLE LLP 2049 CENTURY PARK EAST, 21ST FLOOR, LOS ANGELES, CA, 90067, US

(73) Assignee: John Stannard DAVIS, Corte Madera, CA (US)

(21) Appl. No.: 12/140,003

(22) Filed: Jun. 16, 2008

Related U.S. Application Data
(63) Continuation-in-part of application No. PCT/US2006/062121, filed on Dec. 14, 2006.
(60) Provisional application No. 60/750,934, filed on Dec. 16, 2005.

(51) Int. Cl. G06Q 99/00

(52) U.S. Cl. 705/1

(57) ABSTRACT

A trust-based communication and information filtering system having rating features is user customizable. It is a system in which the raters remain anonymous. The anonymous ratings mimic real life person-to-person recommendation methods wherein recommendations are personal and cannot be controlled by persons or items being rated. The system uses contextually meaningful rating which are filtered explicitly by the end-user or implicitly based upon the environment of the end-user to facilitate discovery and minimize the potential for fraud and deception. Trust networks are constructed between the participants and the rating or information filtered or weighted according to the user's relative trust of the raters in the system. Ratings made by the inventive system can be for goods, services, people, businesses or virtually any item that can be rated and/or recommended.

### CROSS-REFERENCE TO PRIOR APPLICATIONS

The current application is a continuation-in-part of United States patent applications PCT/US2006/062121, filed on 14 Dec. 2006, which in turn was based on and claimed priority from U.S. Provisional Application No. 60/750,934, filed 16 Dec. 2005, the contents of both applications are incorporated herein by reference.

### U.S. GOVERNMENT SUPPORT

Not Applicable

### DESCRIPTION OF THE INVENTION

### Purpose of the Invention and Related Art

This Invention was a result our perceived need for better ratings and information systems than those which are currently available particularly in online environments. We believe that our system addresses widely perceived problems with online commerce and recommendation systems in a way that is unique and valuable to ratings consumers. This inventive system helps prevent or avoid fraud and rating peer pressure (wherein non-anonymous rating parties feel compelled to give inaccurate ratings to others for mutual benefit or to avoid retaliation). The inventive system allows raters to make accurate ratings without concern that their identity can be associated with their ratings. Further, this system allows users to leverage a trusted network of people much as they do in real life-finding personalized, private recommendations and ratings that might be more accurate, meaningful, and effective. The inventive system mimics many aspects of people's real-life social trust networks, yet it affords greater speed, power, and scope because it leverages modern information technology.

The present invention, via the core features explained below, is different from known current efforts to leverage social trust networks in several important ways. It is practical and fairly simple in concept for users to understand; it also provides complete privacy to end-users. It allows users to describe their trust network contextually, and it allows users to understand and control filters applied to ratings based upon their trust network. It also allows users to leverage the various ‘degrees’ or levels of their trust network to gather meaningful data in a way that preserves the anonymity of raters and their individual ratings.

There have been major efforts in this area of the art including the following: 1) Trust Computation Systems which envision and seek to build an automated inferential trust language and mechanism for filtering relevant information and inferring truthfulness and trustworthiness of information and information sources; 2) online social network (Friend of a Friend) systems like Friendster, LinkedIn, Yahoo's “Web of Trust”, Yahoo's “360”, etc. which seek to allow members to leverage social networks for meeting others or gathering information and recommendations; and 3) efforts like the present invention to make intelligent rating systems which leverage trust networks (see, for example, the FilmTrust experimental site). We believe that these earlier efforts fall short in a variety of ways that our system addresses, and we believe that our invention will enhance and improve the value and safety of online e-commerce systems.

### SUMMARY OF THE INVENTION

Core Features

Anonymity: According to the present invention extended trust network members remain anonymous to any user beyond 1 degree of trust network separation from the user. Also, typically, raters remain anonymous, not just to preserve rater privacy, but to promote and facilitate rating candidness and accuracy. Ratings are typically not associated with a particular user. The anonymous ratings are typically non-refutable in this system, and they mimic real life person-to-person recommendation methods whereby the recommendations are personal (in the case of the present invention between people related by a trust network) and are not controllable by the persons or items being rated.

Preservation of Anonymity: Preservation of user anonymity is of paramount importance in this invention and requires non-trivial protective measures. These include having requirements that trusted parties accept ‘trust’ from the trusting party, having threshold numbers of anonymous ratings before showing a composite rating (see FIG. 3), and/or limiting the ability of consumers to manipulate their own trust networks if such manipulation might jeopardize the anonymity of raters. See FIG. 1 for an example of a way to control the creation of trust relationships.

Context of ratings and trust: The system of the present invention is not a general ‘trust’ system, but a system which facilitates discovery, creation, and use of contextually meaningful ratings. To this end ratings can be filtered contextually either explicitly by the end-user or implicitly based upon an end-user's environment. Online auction systems with user ratings provide a classic example of how fraud and related problems can arise if there are no contextual ratings filters: a rating for a seller who sold and received high ratings for selling lots of one dollar tools should not necessarily apply when the same seller attempts to sell million dollar homes.

Trust is relative and not necessarily mutual: if person A trusts person B, person B does not necessarily trust person A. For reasons of preserving anonymity, some embodiments of the inventive system might require that a person ‘accept’ trust from another before a trust relationship can be used by the system.

Trust may be partial even within a given context. Trust can be contextually conditional either explicitly or impliedly depending on an online environment. For example, person A might trust person B's rating of restaurants, yet not trust person B's estimation of kitchen appliances. If an online environment is for rating restaurants, for example, trust context might be implied by the environment. This concept is illustrated in FIG. 4.

Context for ratings and trust can be quite broad, and it can be implied within a certain environment (such as “I trust this person's judgment of sellers on Ebay”); however, preferred embodiments of the present invention can accommodate more detailed contextual filters such as “I trust this person's judgment of auto mechanics”.

Trust may be explicitly controlled by users or inferred by using relative trust formulae across degrees of the trust network. As discussed below, just because person A contextually trusts person B to a certain degree, person A does not necessarily trust the people person B trusts—even in a relative fashion. For example, person A might think that person B is a great physician; yet person B is likely to trust persons who are not great physicians. One embodiment of the inventive system allows users to control the transitivity of their trust (or the amount of inferable trust) beyond the people they trust immediately (i.e., beyond the first degree of trust). See FIG. 4 for one sample embodiment of how this trust can be controlled at the second degree of trust network separation.

An embodiment of this invention might automatically transfer trust contextually, but the user is aware of this (i.e. it is explicit to the user), and the user can choose what “degree of separation of trust” to use for filtering ratings. A less automatic embodiment might allow for finer filtering within the various degrees of trust separation by allowing a user to indicate whether or not (or to what degree) a trusted person's trusted people should be trusted.

Trust Network Ratings Filters: ratings are filtered or weighted according to the viewer's relative trust of raters as determined by the viewer's “trust network.” An end-user can control the “degrees of trust” to use for filtering ratings. An end-user can also choose the filtering algorithm or method which weighs ratings based upon the end-user's trust network relationships. Thus, the ratings are personal or customized for the end-user and two different end-users are likely to see different ratings for the same item, service or person being rated. See FIG. 11 for an example showing how an end-user might select and apply a filter. Examples of potential views of filtered results can be seen in FIG. 12 and FIG. 13.

End-User Controllability: System users control their immediate and extended trust of others. Furthermore, the users can adjust this trust directly or by providing indirect feedback about “trusted information” resulting from use of the system. These adjustment mechanisms are designed and controlled in ways intended to prevent violation of the anonymity of other system users. Rating consumers can (though may not be required to) control which rating filters or weighting schemes are applied to ratings or items they are viewing; thus they are more likely to understand, appreciate, and use the system. In particular, users can control their use of ratings across “degrees of separation” of their trust network (which network keeps users anonymous at least beyond the first degree of trust). A user can be presented with one or more filtering options that can manually be selected, or the user can be allowed to create and store customized filtering templates. This enables users to create and use filters which are valuable to them.

User Feedback Based Trust Correction Mechanisms: The value of this inventive system relies upon the value and personal relevancy of a user's immediate and extended (anonymous) trust. If supposedly useful ratings and information can come from anonymous sources that one “trusts” through trust network extension yet which one does not know and cannot identify, how can such trust be adjusted meaningfully and in a way that preserves the integrity and anonymity of the extended trust system? How can this system continually learn, grow, improve, and become more useful to users? This inventive system includes trust correction mechanisms that correct users' extended trust based upon their feedback in ways that preserve the anonymity of rating and information sources—in most cases by hiding the trust correction details from system users. See FIGS. 18 and 19 and the sample embodiments described below.

Ratings used in the inventive system can be for goods or services, people or businesses, or essentially anything that can be rated and/or recommended. The ratings can be used in many ways ranging from looking up ratings for a seller or potential buyer on Ebay to searching for items rated highly within a certain context (e.g., show me the best plumbers on Craigslist.org using 3 degrees of trust relationship). Ratings can also apply to leisure activities, or entertainment, such as movies, destinations, exercise programs, recipes, etc. The system can even be used for rating of web sites, in either a search engine or a bookmark sharing application. Ratings can also be used programmatically, such as in an anti-spam program or proxy server. Ratings can be displayed in many ways textually or graphically, and they can even be presented in a non-visual manner.

“Degree of Separation” regarding one's trust network is similar to the concept underlying Friend of A Friend (FOAF) systems: people I trust directly are one (1) degree away from me; people I don't trust directly, but who are trusted directly by people I trust are two (2) degrees away from me; people whom I don't trust directly and who are not trusted directly by people I trust directly, but are trusted by people trusted by people I trust directly are three (3) degrees away; and so on (see FIG. 7). This is parallel to the “degrees” in the “six degrees of [social] separation” concept spawned by Stanley Milgram's social network/psychology experiment in 1967 and embodied in the thriving field of science and online social network systems today.

The inventive system can be used separately or in conjunction with other systems. It can be used within a single online population or service or across multiple online populations or services. It could be integral to or separate from the population or service that it serves. Although ideal for Internet use, the inventive system is not limited to the Internet but can be in any form online or offline, across any medium or combination of media, and it can even incorporate manual or non-automated systems or methods.

The inventive system may calculate ratings and user trust entirely ‘on demand’ or it may pre-calculate and store ratings and user trust or portions thereof for use when ratings are demanded. That is, it can be a ‘real-time’ or a ‘cached’ rating system or a combination of the two. The system may also employ conjoint analysis in the pre-calculated ratings. This system encompasses ratings of any form (explicit or implicit, behavioral or associative, etc.) and the ratings can be used for any purpose—automated or not.

For purposes of clarity, there are many potential complexities of this system that are not described in this application. This invention encompasses the core concepts and methods described above and all the methods and solutions for implementing such a system and addressing many of its subtle complexities. Those of skill in the art will readily understand how to deal with such complexities on the basis of the explanations provided herein.

### BRIEF DESCRIPTION OF DRAWINGS

FIG. 1 shows sample input forms; FIG. 1A shows settings by which a user selects trust relationships; and FIG. 1B shows the settings by which a user controls his relationship to another trust network.

FIG. 2 is a diagram illustrating how anonymity can be broken in a one way trust network.

FIG. 3 is a diagram illustrating how a requirement for a threshold number of ratings can preserve user anonymity.

FIG. 4 shows a sample form by which a user can set trust levels the user has for other users; FIG. 4A shows a form for setting trust levels for different items; and FIG. 4B illustrates setting for transferred trust.

FIG. 5 illustrates a simple form for rating various aspects of a babysitter's performance.

FIG. 6 illustrates a simple form for rating a restaurant.

FIG. 7 is a diagram of a single trust network between four users and one seller.

FIG. 8 illustrates a double trust network involving five users and one seller.

FIG. 9 illustrates a one degree of trust filtering network.

FIG. 10 illustrates a two degrees of trust filtering network.

FIG. 11 illustrates a simple input form for setting rating filtering criteria.

FIG. 12 illustrates sample filtering results.

FIG. 13 illustrates an additional way of displaying sample filtering results.

FIG. 14 illustrates a sample architecture for a trust based rating system according to the present invention.

FIG. 15 illustrates details of the architecture of a “circles of trust” distributed rating system according to the present invention.

FIG. 16 illustrates the detail of the architecture of a “circles of trust” system that includes an interface to a trust network information system.

FIG. 17 is a diagram showing the steps of using a “circles of trust” rating system.

FIG. 18 is a diagram showing how, in some embodiments, a user might correct personal trust network trust levels by providing rating feedback in a way that does not violate the anonymity of other users.

FIG. 19 illustrates how trust levels might be corrected or adjusted along a path of trust based upon user feedback as given in FIG. 18.

### DETAILED DESCRIPTION OF THE INVENTION

The following description is provided to enable any person skilled in the art to make and use the invention and sets forth the best modes contemplated by the inventors of carrying out their invention. Various modifications, however, will remain readily apparent to those skilled in the art, since the general principles of the present invention have been defined herein specifically to provide a method for producing an improved trust-based rating system.

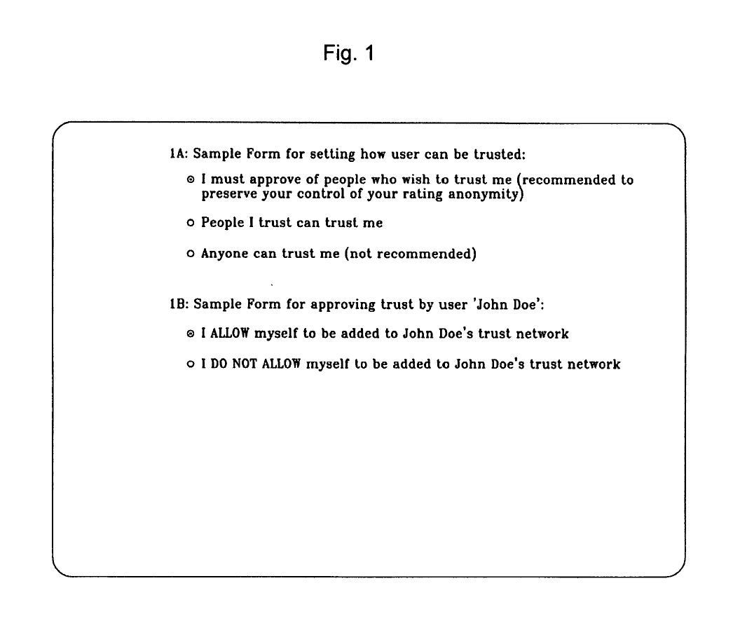

FIG. 1 shows sample forms for an embodiment which allows a system user to control who can trust them (a possibly crucial way to preserve rater anonymity). In FIG. 1A the default mode (recommended) gives the user control over which other parties are permitted to trust that user and thereby extend their trust networks by using the user's network. The opposite setting is to allow anyone to trust the user. With that setting anyone can leverage the user's trust network; therefore, this setting is not recommended. The middle setting is an interesting compromise in which any member of the user's trust network can trust the user and thereby leverage the user's trust network. FIG. 1B illustrates a control that gives the user specific control over which other parties are allowed to add the user to their trust network. This is a more specific way in which a user can control the leveraging of the user's trust network. As will be explained below, when a person is added to a trust network, it is possible to have that existing network extend to include any (or part of) a trust network owned by the added person. This allows the use or “leveraging” of that person's trust network.

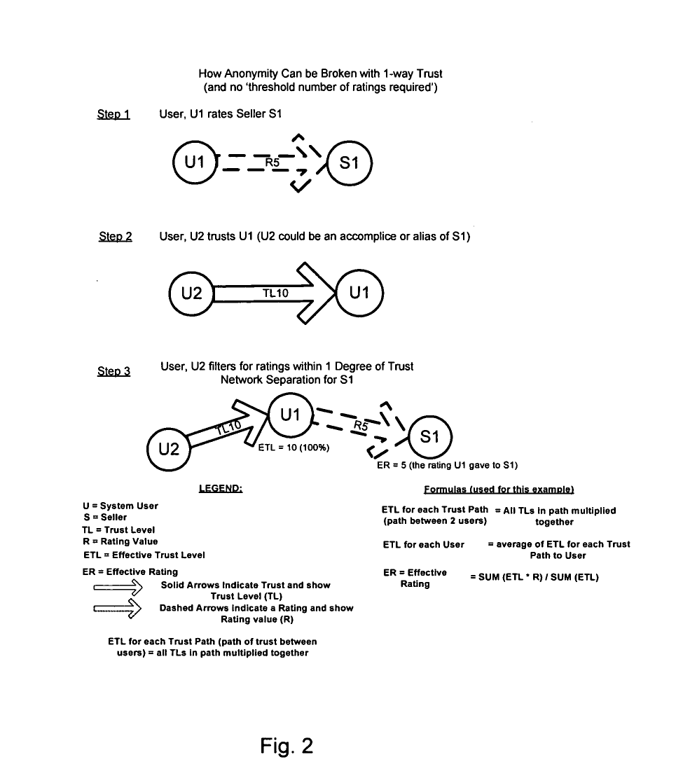

FIG. 2 illustrates steps for one of the risks for loss of anonymity of rating associated with selecting the ‘not recommended’ option on the form in FIG. 1A (i.e., by a user's allowing ‘1-way trust’ in a system with other protections such as a ‘threshold number of required ratings’). In step 1, the user (consumer, U1) rates a seller (S1). In step 2 the seller leverages another user account or alias (U2) and trusts the user (U1)—this can be done because U1 accepts ‘1-way trust’. In step 3, U2 looks up the 1 Degree of separation rating for S1 (the original seller account) and, if the system allows this, U2 can discover the rating of S1 given by U1—thus breaking the anonymity of user U1's rating. There are many more sophisticated versions of this type of risk to anonymity that implementers of this system will have to consider. For this and all other drawings, S could just as well indicate an item, service, business, or any other thing which could be rated. Here the Effective Trust Level (ETL) for each trust path is all the Trust Levels (TL) for the path multiplied together. The ETL for a user is the average of the ETLs for the trust paths to the user. Then the Effective Rating (ER) for a trust path is the sum or the ETLs times the Rating value divided by the sum of the ETLs.

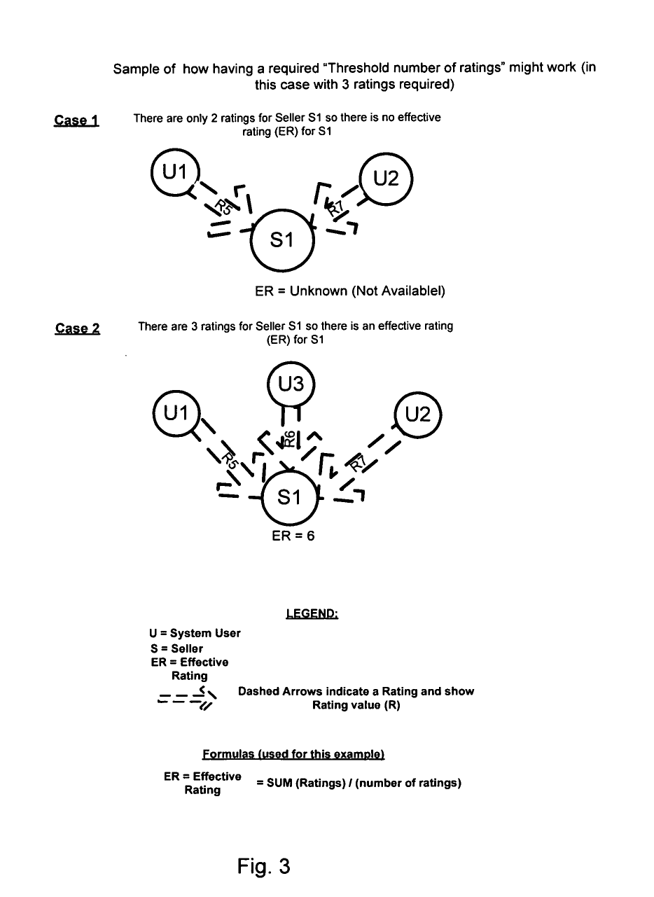

FIG. 3 illustrates how a ‘threshold number of required ratings’ might apply for a single seller (S1). Such a threshold can be applied to the system in general or to a particular trust network filter. Typical embodiments of this system will have a threshold of at least 2 to preserve anonymity of the first rater of the seller. Case 1 shows that there is no effective rating (ER) for a seller with only two ratings in a system which has a ratings threshold filter of three ratings. Case 2 shows the effective rating (ER) for the seller once three ratings have been given—these meet the threshold criteria and an aggregate rating is shown. Here the Effective Ration (ER) is the average of the three (or more) Ratings. That is it is the sum of the Ratings divided by the number of Ratings.

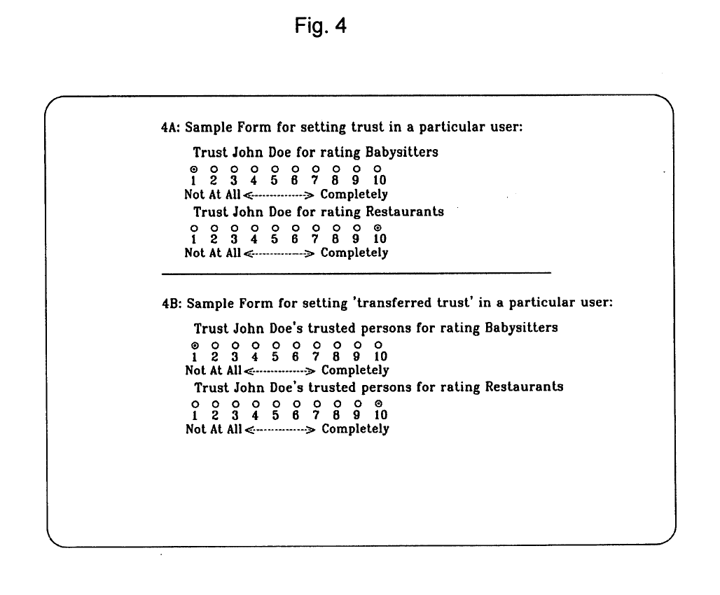

FIG. 4 shows a sample form for an embodiment of the system that allows a user to indicate contextual trust for another user and contextual trust for that other user's contextually trusted persons. In FIG. 4A the user selects the degree of trust applied to the ratings of another user according the character of what is being rated (context). In FIG. 4B this is applied to the transferred trust of the other user—that is to what degree the network should be extended to include the trust network of the trusted party. As will be explained below, a user has control over the ability of another party to use or “leverage” the user's trust network. Contextual trust could in some implementations be implicit in an environment or it could be broader or more succinct than the sample given.

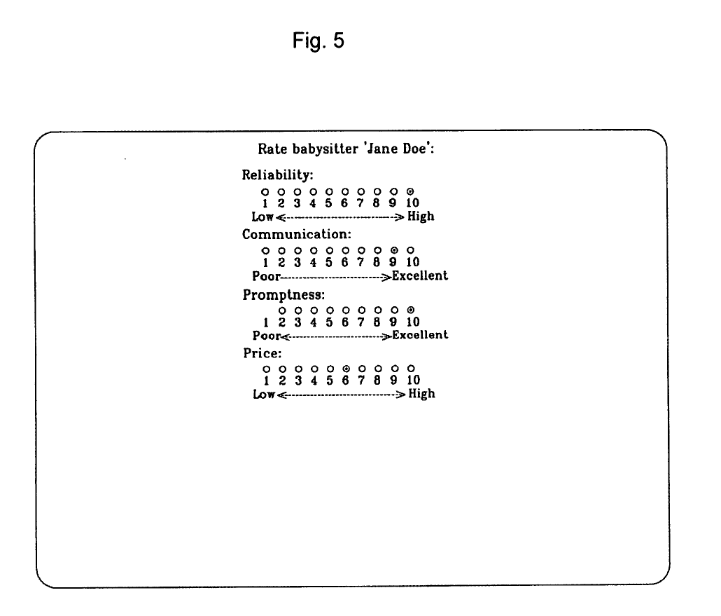

FIG. 5 shows a sample form which a user might use to rate a ‘babysitter’ on several criteria. Some embodiments might have ratings that are less detailed and others might have more detailed ratings. The inventive system is not necessarily restricted by the complexity of ratings.

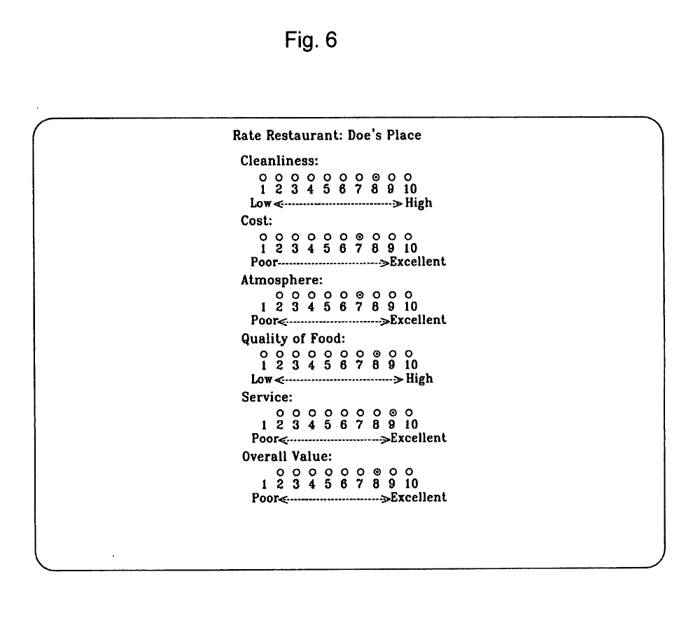

FIG. 6 shows a sample form which a user might use to rate a restaurant on several criteria.

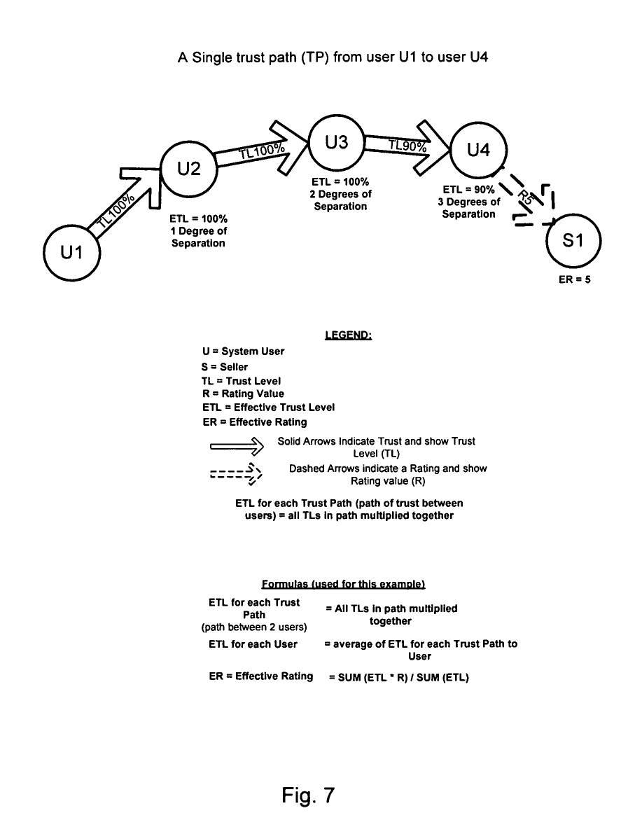

FIG. 7 illustrates the concept of a trust path (TP) and Degrees of Trust Network Separation. A trust path (TP) is shown from user U1 to user U4 (who has rated seller S). U2 is immediately trusted by user U1 and is ‘1 Degree of Trust Network Separation’ from user U1. User U3 is immediately trusted by U2 (but not directly by U1) and is ‘2 Degrees of Trust Network Separation’ from U1. U4 is trusted by U3 (but not directly trusted by U2 or U1) and is hence ‘3 Degrees of Trust Network Separation’ from U1. Again, the Effective Trust Level (EFT) for a whole trust pass is all the individual Trust Levels (TL) in the path multiplied together. The ETL for any user is the average of the ETL for each Trust Path to the user. The Effective Rating (ER) is the sum of the products of each ETL and the Rating divided by the sum of the ETLs. Here the sum of the product of the ETL and the Rating is 1450 (450+500+500), the sum of the ETLs is 290 (90+100+100) so that the ER is 5 (1450 divided by 290). Again each user can have control over whether of not another user is trusted or can trust them.

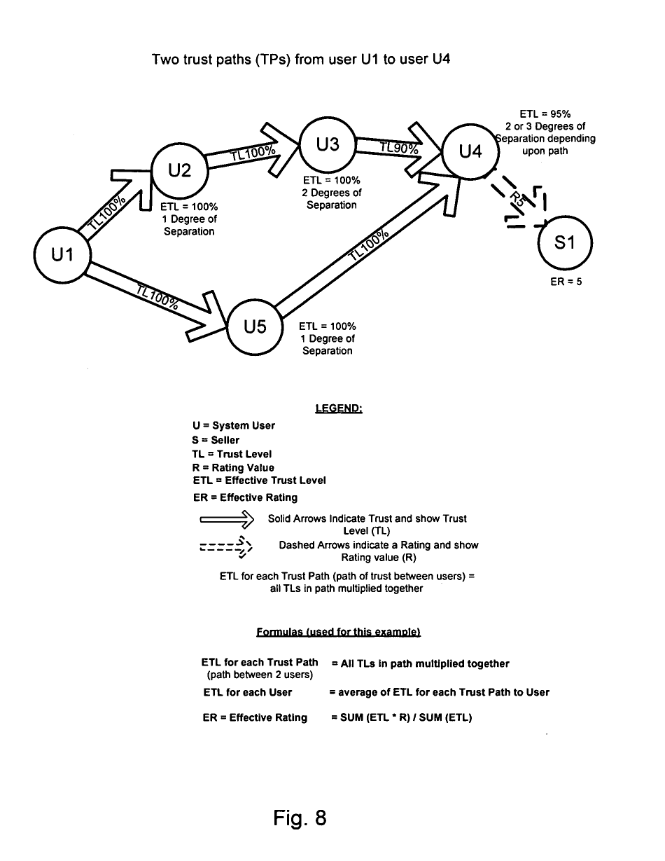

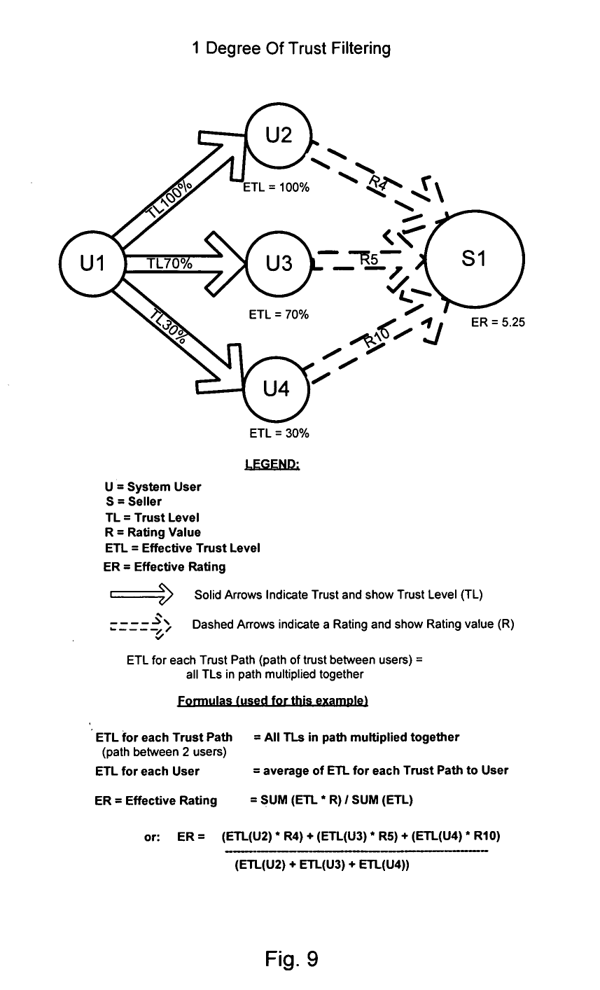

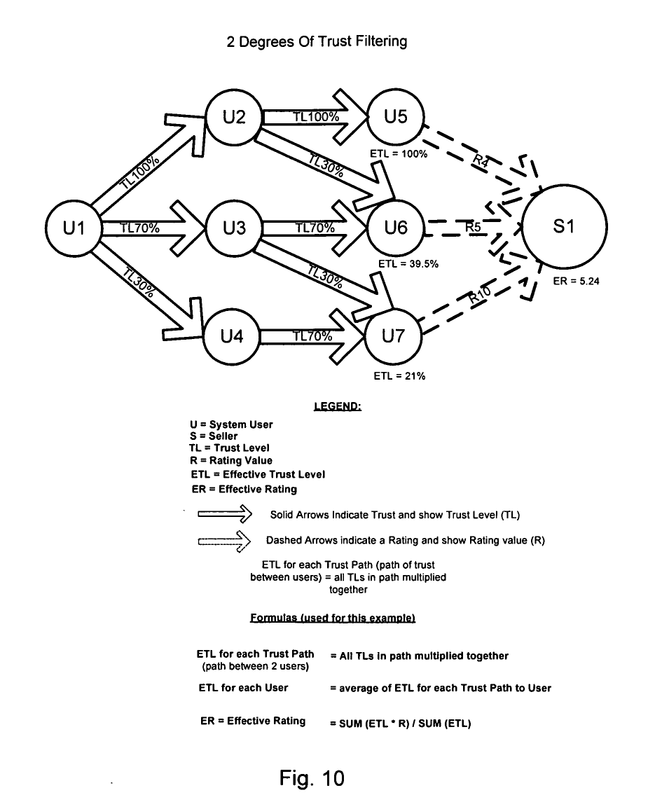

FIG. 8 illustrates one embodiment where trust paths (TPs) which share the same beginning and end point can be used in combination to determine effective trust levels (ETL) and effective rating (ER) for a given rater (U4) and seller (S). In this case there are two trust paths between consumer (U1) and rater (U4). One is 2 Degrees of Trust Network Separation with an effective trust level (ETL) of 10 (100%). The other is 3 Degrees of Trust Network Separation with an ETL of 9 (90%). If both trust paths are taken into account equally for a single rating (the case in some embodiments of the inventive system), then the average ETL for the rater (U4) would be 9.5 (95%). See FIGS. 9 and 10 for other related examples. The same formulae are used here as in FIG. 7.

FIG. 9 shows one embodiment of a method for calculating effective rating (ER) for a ratings filter for One (1) Degree of trust network separation. There are a virtually unlimited number of similar methods which can be used in the inventive system for all degrees of separation of trust network relation, and there are many subtle and potentially complex issues that must be managed. This particular method causes the effective trust level (ETL) for each rater to be used to proportionally weigh the trusted person's rating for a given rated item, which is in this case a seller (S1). In this case, where the filter uses ratings that are 1 Degree of separation in the trust network from the user (ratings consumer), the effective trust level (ETL) is equal to the trust level (TL) the user has assigned to each rater. The effective rating (ER) is the sum of each rater's effective trust (ETL) multiplied by each rater's rating and divided by the sum of the raters' effective trust levels (ETL). The end result is a single calculated effective rating (ER) which is weighted according to the effective trust levels (ETL) for the given raters. The ER is calculated by dividing the sum of the ETL for each user times the rating for that user by the sum of the ETLs of all the users.

FIG. 10 shows one embodiment of a method for calculating effective rating (ER) for a ratings filter for Two (2) Degrees of trust network separation. As with the method in FIG. 9, this particular method causes the effective trust level (ETL) for each rater within the user's trust network to be used to calculate a single effective rating (ER) for a seller (S) which is weighted according to the effective trust levels (ETL) for the given raters. The difference here is that the effective trust level (ETL) for each rater must be calculated from the trust levels (TL) of each node in a ‘trust path’ (TP). A trust path is a single path of connected trust nodes within a trust network from one person to another—in this case the filter uses trust paths (TP) of Two (2) Degrees of separation. This formula and method is only an example of how this system can work. A variety of formulae and methods can be used in this system.

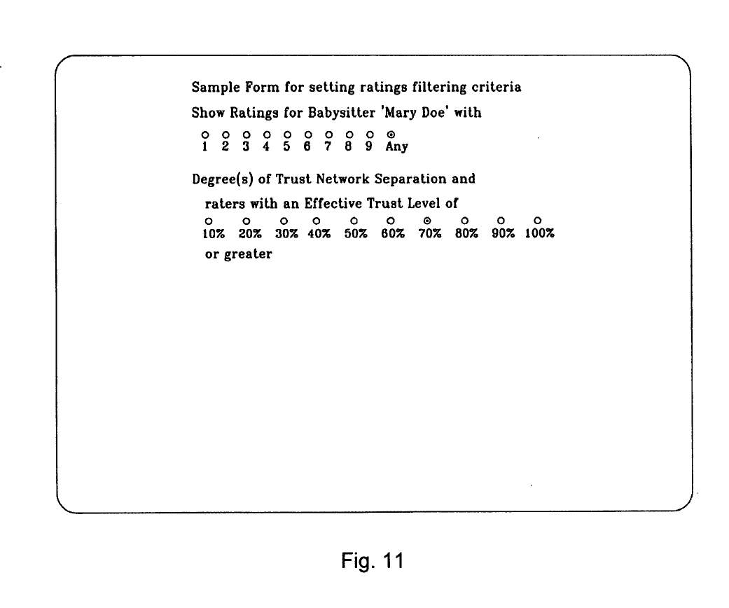

FIG. 11 shows one embodiment of a form which allows a ratings consumer to select or specify ratings filter criteria. The user can view the ER for (here a baby sitter) derived from networks having the specified degrees of trust network separation. The user can also select the trust levels to be used. Thus, where there is a large database of trust information, these criteria allow a user to “prune” the trust network in a number of different manners and view the effect on the end rating.

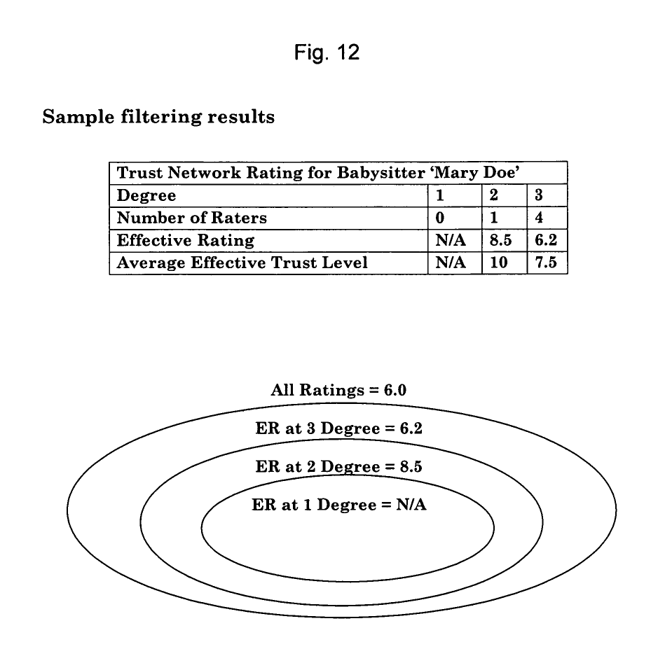

FIG. 12 shows one embodiment of how filtered rating resulting for filtering in FIG. 11 might be presented. Here ratings are shown in a table as well as graphically, and they display available aggregate ratings data for each of the first three (3) degrees of trust network separation as well as the aggregate rating data for all ratings for the seller. This can show the user that this seller might be more likely to be satisfactory than the seller's overall ratings might indicate. That is, the average overall rating is 6.0 but the rating at two degrees of separation is 8.5. However, the user might not find the data strong enough (i.e., a relatively small number of raters) to support a particular action. Note that this system enforces anonymity by not showing results for less than two degrees of separation.

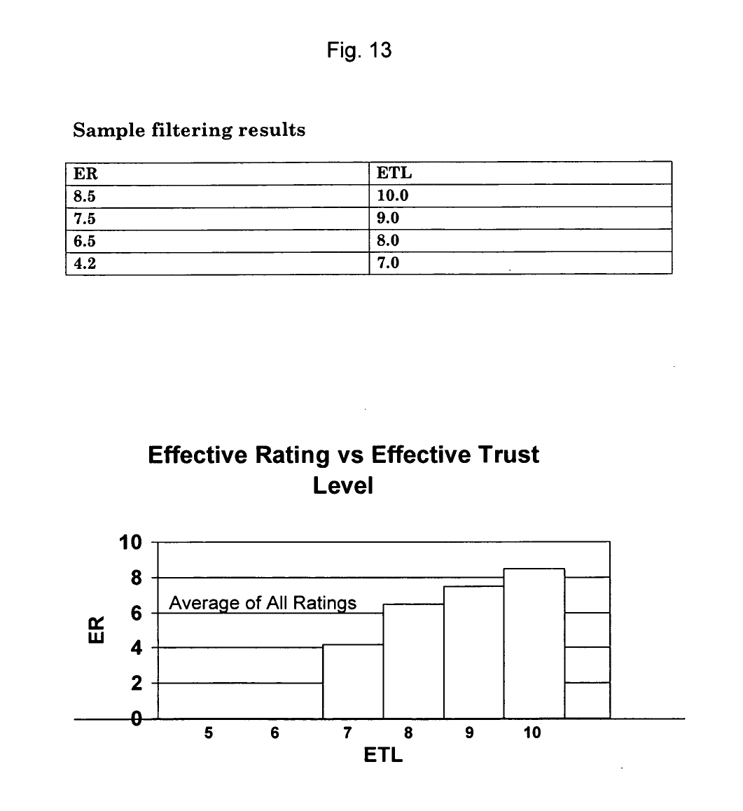

FIG. 13 shows another embodiment of how filtered rating results can be calculated and presented—the ‘degree of trust network separation’ is not shown graphically but the effective trust level (ETL) and effective ratings (ER) are graphically displayed. This more clearly shows an upward trend in ratings the more the user trusts the raters since ETL is shown by value rather than by average for a given degree of trust network separation (TNS).

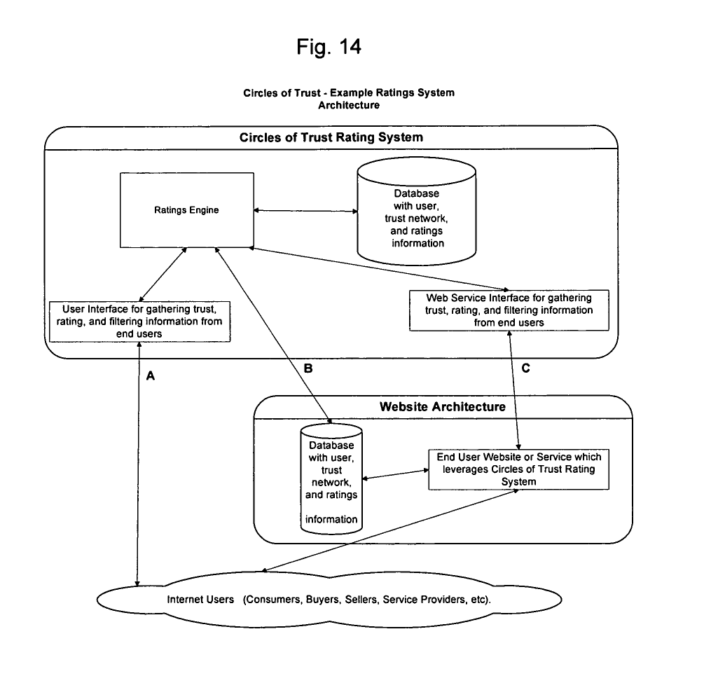

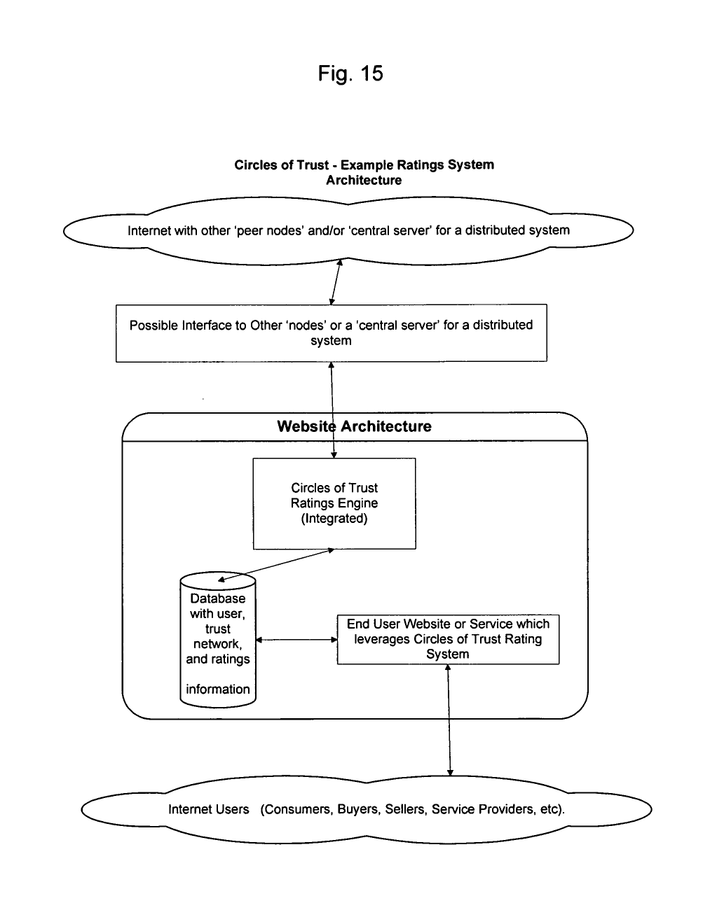

FIG. 14 is an illustration of typical components in one implementation of the inventive system from an application component perspective. Here user input can be gathered directly from the “Circles of Trust Ratings System” (Interface A—a possible interface to the inventive system), from an integrated client database (Interface B) or through a third party website via an API (application program interface), web service, or integrated functionality (Interface C). Ratings information which the Ratings Engine calculates using users' ratings and trust network information can be displayed to the user via Interface A or through a client website using Interface B or Interface C (or any combination of these types of interfaces). For reasons discussed below, the Ratings Engine would typically be a separate system from the e-commerce site, though it may, in some embodiments, be an integral part of a ‘client’ website (or other type of client) as well (e.g., see FIG. 15).

FIG. 15 is an Illustration of typical components in another embodiment of the system from an application component perspective. Here the “Circles of Trust Ratings System” obtains required user, trust network, and ratings data directly from a database that it shares with a website or web service that leverages the Circles of Trust Ratings System. This could comprise one independent ‘node’ of a larger ‘distributed network’ of independent systems which implement the inventive system.

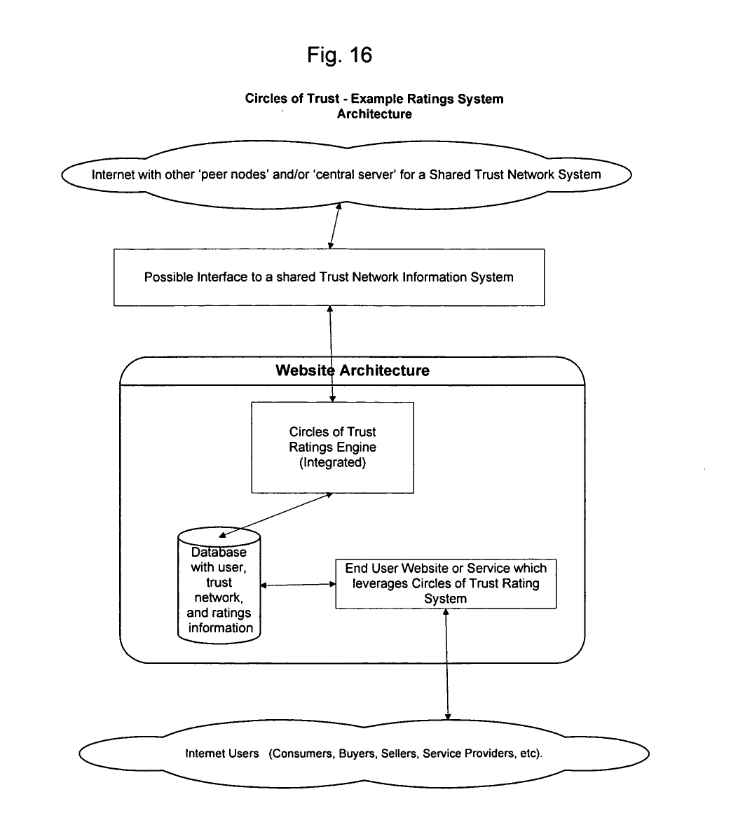

FIG. 16 shows components for an embodiment of the system which leverages a Shared Trust Network. In such an embodiment rating information might not be shared externally (as in the embodiments in FIG. 15), rather just the trust network information would be shared externally. This shared trust network information might include trust relationships, trust levels, and, in some embodiments, the trustee's control of how their ratings information can be used (that is, who can trust them and to what extent others can use their individual trust networks). The advantages of such an embodiment is that system users can leverage their trust network information across separate sites and services while maintaining their trust network information in a single location only. The individual systems/nodes in such an embodiment may or may not allow users to manage/update their Shared Trust Network information directly in a way that affects the users' global or Shared Trust Network information across sites. The Shared Trust Network may provide information that is read only or it might allow read-write access for updating of users' Shared Trust Network information for each node or service that uses the Shared Trust Network information for its users. There are many ways of protecting users' Shared Trust Network information in such embodiments that are necessary and obvious to those skilled in the arts—these could include encryption, authentication for access, and use of positively identifying information or authority for individuals whose Shared Trust Network information is being used.

It will be apparent to one of skill in the art that the various activities or processes to implement the present invention are best carried out by one or more computer programs. The means for designating the members of a trust network (the trustees) as well as the context and degree of trust can be carried out using input screens such as those illustrated above. Such forms are also advantageously used to input rating information. After all the parameters have been input, the program can readily calculate the trust levels, effective trust levels and effective rating using the formulae given above. Once these results are available they can be displayed graphically—for example as in FIGS. 12 and 13.

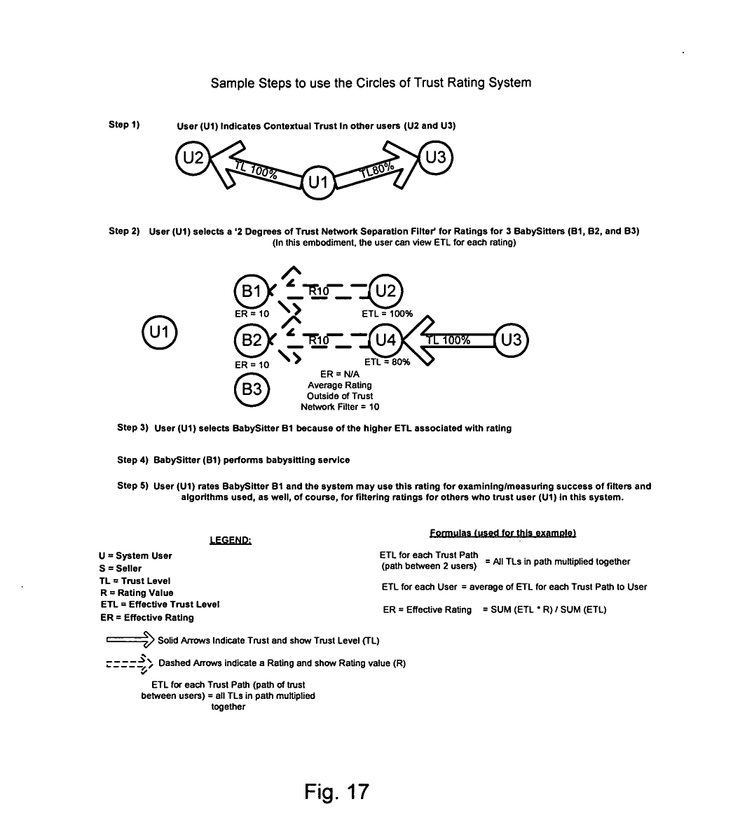

FIG. 17 illustrates the steps a user could go through to use one embodiment of the inventive trust network based ratings system. This implementation relies upon the user being able to see the Effective Trust Level (ETL) for each Effective Rating (ER) in order to make the probable best choice. In a first step the user (U1) indicates the level of trust in other users (U2 and U3). In a second step the user U1 selects a 2 degree of trust network separation filter to evaluate rating of three different babysitters (B1, B2 and B3). Results are available only for B1 and B2 because neither of the other members (U2 and U3) of the network have rated babysitter B3. Note that U3's own trust network includes U4 and because a 2 Degree filter is used U4 is included here (U4 has 2 Degrees of separation from U1). In the third step the user selects B1 because although both B1 and B2 received a rating of 10, the ETL is higher for B1 because U1 trusts U2 100% but trusts U3 only 80%. In the fourth step B1 performs the service (babysitting), and in a fifth step U1 rates B1 performance. The system can then confirm the effectiveness of the filters and algorithms assuming that U1 also gives B1 a high rating. If U1 gives B1 a low rating, it may be necessary to adjust the Trust Levels—for example the Trust Level of U1 to U2 can be adjusted to lower the Effective Rating of B1 to match the results of U1's rating. The process is a continuous reiterative process whereby the networks are constantly adjusted and refined as more data becomes available. Other implementations can use an algorithm to change the ER values based upon the ETL or other factors. Of course, the end-user can see and control the filters used.

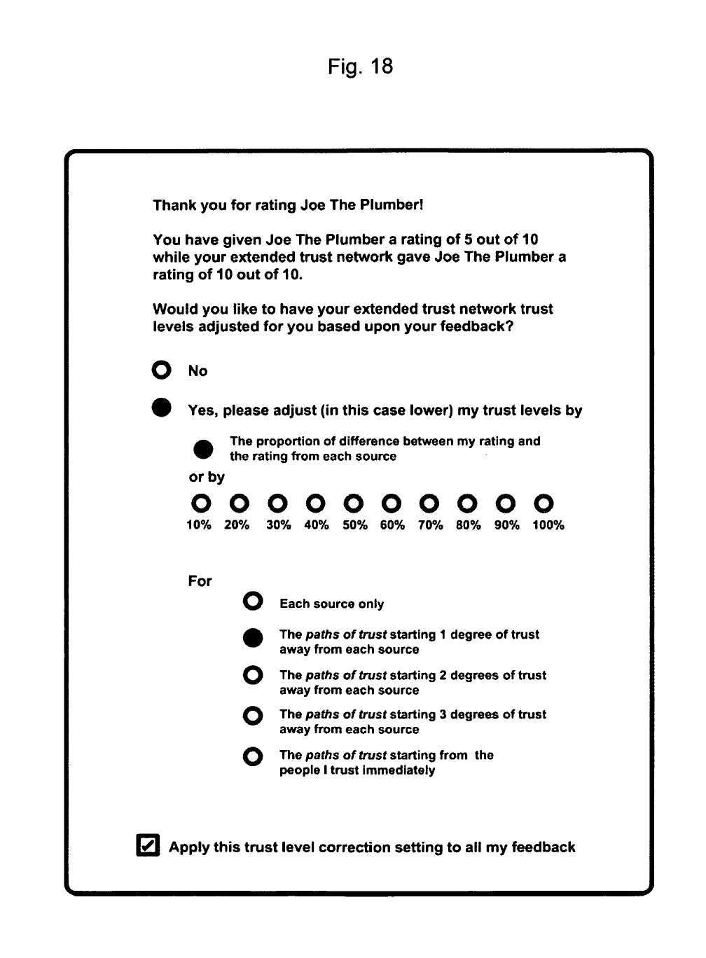

FIG. 18 shows a possible user interface for an embodiment which allows users to adjust their trust network trust levels after providing feedback regarding the ratings received from use of the trust network system. In this sample embodiment, the user has given a rating of 5 out of 10 for a plumber who was rated 10 out of 10 by the user's extended trust network. Based upon this discrepancy in ratings, the user is offered options for correcting personal trust network trust levels. Adjustment options include amount/method of adjusting trust levels and whether adjustments should be for rating sources only or along various degrees of trust path connection from the user to those rating sources. Also, in this sample embodiment, the user is given the opportunity to keep the selected choices as a ‘default’ setting for future, possibly automated or semi-automated use in adjusting the user's trust network trust levels based upon the user's feedback. Trust network trust levels can be adjusted in any number of ways in various embodiments of this system, and there is typically significant complexity to the details of such methods which are obvious to those skilled in the relevant arts. In some embodiments the system can be configured to allow the user can to “try out” the adjustments and view their effect on several different ratings. However, any “try out” system must be configured to preserve the anonymity of rating sources. A preferred way of handling these adjustments is also to provide an “automatic” default mode that can be selected to make the adjustments for users not interested in “fine tuning” the criteria.

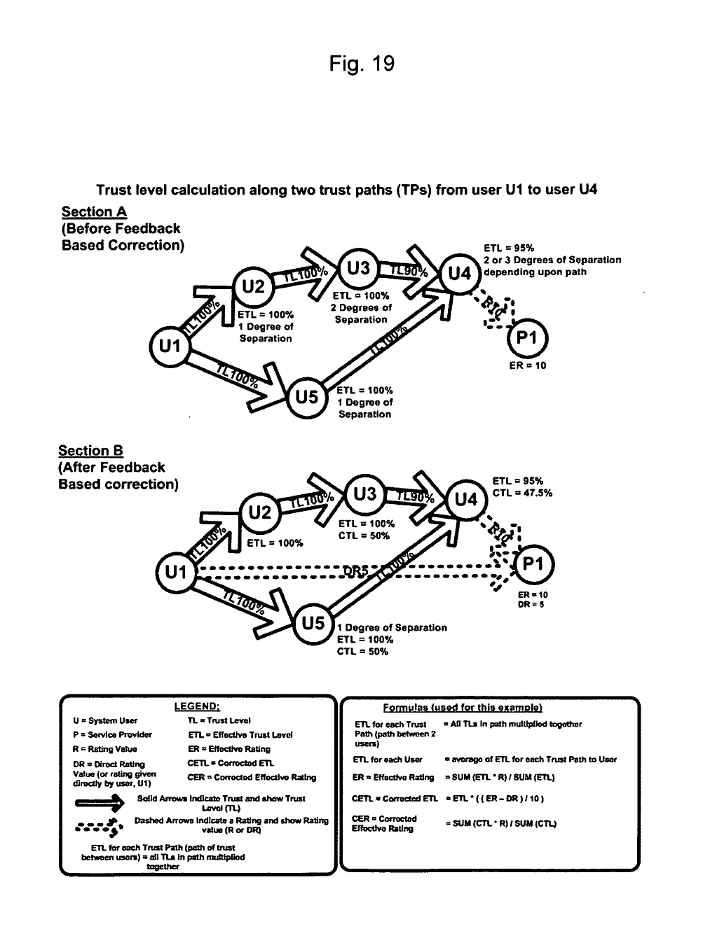

FIG. 19 illustrates an example of how a user U1's personal trust network trust levels can be adjusted based upon the choices selected in the example in FIG. 18. Section A shows the ‘before adjustment’ effective trust levels (ETLs), and the ‘after adjustment’ corrected trust levels (CTLs) are shown in Section B. In this example, the user U1 has chosen to correct trust levels for the extended trust network member U4 who rated the given plumber P1 as well as for the direct trust network members U3 and U5 within 1 degree of trust of the rating member U4. The user in this example, chose to correct the trust levels in proportion to the difference between the calculated rating ER and the actual rating DR that the user U1 provided for the plumber P1. In this case the ratings (DR and ER) differed by 5 points out of 10 so the corrective factor is 50%. Effectively, the ratings from the affected members who had their trust levels corrected (U3, U4, and U5) would have a trust level only 50% that of the original uncorrected trust level. The corrected trust levels (CTLs) would typically take precedence over the uncorrected trust levels (ETLs) going forwards and ratings from the members (U3, U4, and U5) might have much less weight or influence for the user U1 and others who leverage the extended trust network of the user.

Had different trust network trust level correction options been chosen by the user, different trust network nodes may have had their trust levels adjusted and different algorithms and methods for such adjustment may have been used. This inventive system can use any of a variety of algorithms for adjusting trust levels and embodiments of this system might provide options for correcting trust network trust levels based upon a user's feedback. Typically, the trust level correction details and the corrected trust levels (CTLs) would be kept hidden from users of the system for the purpose of securing the anonymity of extended trust network members.

System Components

The system components are described using a sample embodiment with an online e-commerce system where buyers and sellers can rate each other (see FIG. 14). First, an e-commerce website gathers and stores users' ratings, ratings context, and contextual trust network information. The system provides a Mechanism/Method for allowing users to understand and control the calculation and presentation of ratings based upon their contextual trust network while preserving the anonymity of raters.

Mechanism/Method: The interaction of components of a Ratings Engine for calculating/filtering users' ratings based upon a viewer's contextual trust network association with raters can be seen in FIGS. 14 and 15. Essentially an e-commerce website with a population of using buyers and sellers collects and stores users' anonymous ratings of each other (typically only those with whom they've transacted) and transactional information necessary to provide a rating any needed context (e.g., type of transaction, date of transaction, type of item sold, cost of item, type of payment, etc.). The system accommodates the gathering and storage of users' trust network information in a way that can be related to particular system users. This can be through users' aliases, email accounts, phone numbers, etc. so that there is some means of identifying individuals definitively for trust network and ratings calculation purposes.

Next, users who have trust network data entered in the system can select a ratings filter or view based upon various aspects of their trust network (e.g. Degrees of Trust Network Separation and/or Effective Trust Level of raters). The ‘Ratings Engine’ then calculates trust network-based ratings values according to the filter selected by the user in a way that preserves rater anonymity. These ratings, which may be calculated in real-time or may be partially or wholly pre-calculated, are passed back to the user for viewing in a manner that preserves rater anonymity. The user interface for gathering trust network data and displaying ratings information based upon the user's trust network information may be integral to or separate from the e-commerce website application. Thus, the ratings system can be comprised of a separate system, software application, and/or hardware appliance which handles all of the trust network-based information gathering and ratings filtering, or it can be comprised wholly or partially of pieces of software and hardware integral to the e-commerce (or other) system or online population which it serves.

FIG. 16 illustrates how a user interacts with one embodiment of the system. First the user sets up the system by indicating trusted persons by means of user aliases, ids or other user identifying information such as email addresses or phone numbers and the contextual trust level for other users (this may require approval by trusted persons). Then the user applies an anonymous trusted persons filter to the item/service/or person to determine the rating (based on stored rating data). As a result the user can view the trust network filtered ratings which are calculated by the Ratings Engine using the user's trust network information and the user's selected filter and view settings. The user then buys, rents, uses, or transacts (partially or wholly) with item/service/person. At the conclusion of the transaction the user (typically) rates the item/service/person (possibly based upon multiple criteria). This information becomes part of the rating database for use by future users. In addition, the user's rating data may be used as feedback by the Ratings Engine to examine and adjust the user's trust network or filtering settings (typically by prompting the user) or to adjust or create filtering algorithms to increase the usefulness of the system. If the network is optimally configured, the rating suggested by the system and the rating given by the user should be similar or identical.

Preferred Embodiment: An optimal way of using the invention will be the creation of an independent system that gathers users' trust network information and filters ratings based upon this. This will allow the system to more easily scale and grow on its own and will allow such a system to serve more than one client service population (e.g., multiple e-commerce sites) at the same time. This can allow users to have much more broadly useful ratings filtering tool that follows them from service to service as opposed to their trust network being bound and custom to a single online environment. Of course, context of ratings and trust remain an important aspect of any implementations of this system.

Advantages: The inventive system puts control in the hands of the end-user and mimics aspects of real-life trust network usage while leveraging modern technology. It also addresses common concerns for privacy and ratings accuracy. It can accommodate user's trust of ‘third party associations’ which authorize or approve online business entities' and persons' identities and/or history and which may provide their own ratings that may be useful to system users. This system is based upon concepts that will be familiar and simple for people to understand and trust. The invention allows them to avoid concerns common to other systems which don't clearly reveal to the user how ratings or rankings are created (e.g., Google's ranking of search results is problematic at best in that rankings can be manipulated through various means), which have issues of possibly inaccurate ratings because of social/business pressures (Ebay and other non-anonymous ratings systems) or which may be more likely to be vulnerable to fraud (Ebay, etc.). We believe that people will increasingly demand this type of ratings and information control as they become more sophisticated users of online services.

Alternative Embodiments: This rating system can be used separately or in combination with other rating systems, filters or methods. Certain embodiments of this system might use a distributed, possibly peer-to-peer (or other), architecture or a combination of system architectures. Ratings may or may not be presented in aggregate form—that is individually or in combination—as long as rater anonymity is preserved and protected by the system. Ratings may have persistence (e.g., be fixed in time so a single user can give several ratings to another) or not (e.g., where a single user has a single rating for another and can adjust that rating at any time) or may combine different types of persistence. In one embodiment raters can optionally not be anonymous (i.e., unmasked) within the first degree of trust network relation. In another embodiment users might allow their trust network to be leveraged automatically or semi-automatically on their behalf in ways that they can control and understand and that are in line with the core elements of this invention. In still another embodiment users might allow their trust network to be populated automatically in some fashion (such as importing an address book) while being able to control and understand the trust network in ways that are inline with the core elements of this invention.

Trust Networks relationships need not be entered and managed manually (though it is important to this system that users be able to view and control their trust networks). There are possible ways of automating the gathering of ‘inferred’ trust from various data sources and patterns—for example through typical “semantic web” methods, and through tools and interfaces which allow sharing or exchange of personal lists or trust network information. In one embodiment ratings could also be filtered by date—so users can historically see ratings changes or see most recent ratings if desired. There are many other possible filters that can be used in this system. In fact, by allowing people to build their own custom filters (and by inferentially studying the data gathered by consumer trust networks, filter usage, and ratings) this system can provide continual opportunity to create and improve filters (and formulae) that can be implemented by the system so that such a system would continually grow and improve.

One embodiment of the inventive system ‘normalizes’ raters' ratings based upon a formula or test that can include consideration of the raters' history and effective rating range. The idea here is that one rater may only habitually rate things from 0 to 5 on a 0 to 10 scale whereas another rater might only rate things from 5 to 10 on that same scale: effectively, a 0 for one rater might be a 5 for another and a 5 for one rater might be a 10 for another, etc. Thus, embodiments of the inventive system may attempt to ‘normalize’ raters' ratings to adjust for such variation in the raters' habitual scales.

Another embodiment of this system can allow third party filters or algorithms to be ‘plugged in’ to the system through an API (application program interface) or the like to provide a distributed model, which can leverage different algorithms, filters and methods at different ‘nodes’ in the system (see FIG. 15 for what a single ‘node’ might look like in such a distributed system). It is also possible to select trusted individuals for a user's trust network on the basis of demographic, educational, professional, financial or other personal characteristics of the trusted individuals.

An additional embodiment of the inventive system allows users to choose to trust raters who are members of a group or association (e.g., “trust members of the Rotary Club”). This embodiment may or may not require trusted parties to accept trust. Other embodiments allow users to choose to trust an organization's ratings (e.g., “trust the Better Business Bureau ratings” or “trust Consumer Reports ratings”).

Still another embodiment of the inventive system allows users contextually to control their anonymity—possibly allowing a list or group of persons to see their identity regardless of degrees of Trust Network separation. This would be contextual, for example “allow anyone from my mother's club to view my identity in the context of my ratings for babysitters but not in the context of my ratings of music videos.”

Other embodiments of the system might allow raters to control how their ratings can be viewed/used by others. For example, a rater might be happy to share ratings for babysitters with trusted friends within one (1) degree of trust network separation, but not wish to share babysitter ratings with persons beyond one (1) degree of trust network separation. In another example, a rater might wish to share personal rating information across any degree of trust network separation and even publicly. Such embodiments would allow users to control how their ratings information can be used in such ways.

In one embodiment of the system the trust network information might be shared outside of the specific system in a manner such as that illustrated by FIG. 16.

In some embodiments of the system, a user's personal extended trust network can be used without the accompaniment of ratings to view, access, use, or filter email, opinions, information, and/or communications based upon the user's trust levels for the information or communication sources. For example, a user in one embodiment might desire to receive and have email messages from other users who have a trust level higher than 9 out of 10 forwarded to a personal cell phone for immediate attention, while having messages from users with trust levels below that delivered elsewhere or blocked entirely. Other embodiments include forums, online communities, opinion and recommendation systems, and/or information systems, including search engine systems, wherein users might want to filter information based upon their trust for the information sources as calculated using their personal extended trust network.

In some embodiments, users' personal trust networks can be enhanced or adjusted by a trust correction mechanism that operates based upon users' input and with the user's general knowledge and approval. In some embodiments some or all of the details of such trust correction are hidden from the users for the purpose of protecting the anonymity of users and the value and integrity of the system as well as avoiding intimidating complexity.

The following claims are thus to be understood to include what is specifically illustrated and described above, what is conceptually equivalent, what can be obviously substituted and also what essentially incorporates the essential idea of the invention. Those skilled in the art will appreciate that various adaptations and modifications of the just-described preferred embodiment can be configured without departing from the scope of the invention. The illustrated embodiment has been set forth only for the purposes of example and that should not be taken as limiting the invention. Therefore, it is to be understood that, within the scope of the appended claims, the invention may be practiced other than as specifically described herein.

What is claimed is:

1. An extended personal trust network system containing individual members comprising:
means for each member to designate trustees who are trusted other members, the context of such trust and the degree of such trust, thus forming a personal trust network connected to the member wherein each trustee can also have a connected personal trust network;
means for ensuring that contents of each member's personal trust network remains private and personal and unknown to other members of the personal trust network;
means for each member to specify to what extent and in what context the member trusts the personal trust network of each of the member's trustees, the resulting trusted personal trust networks of each trustee thereby forming an extended personal trust network of the member;
means for each member to control to what extent and in what context other members can designate the member as a trustee;
means for each member to specify in what context and to what extent other members who have designated the member as a trustee can use the member's connected personal trust network as an extended personal trust network; and
means for ensuring that members of the extended personal trust network can remain anonymous.

2. The trust network system according to claim 1 further comprising means for calculating an effective trust level for a path between each pair of members.

3. The trust network system according to claim 2, wherein said trust level calculations are used to find, share or filter data including ratings, recommendations and opinions.

4. The trust network system according to claim 2, wherein said trust level calculations are used to find or filter electronic messages or communications.

5. An extended personal trust network system containing individual members comprising:
means for each member to designate trustees who are trusted other members, the context of such trust and the degree of such trust, thus forming a personal trust network connected to the member wherein each trustee can also have a connected personal trust network;
means for ensuring that contents of each member's personal trust network remains private and personal and unknown to other members of the personal trust network;
means for each member to specify to what extent and in what context the member trusts the personal trust network of each of the member's trustees, the resulting trusted personal trust networks of each trustee thereby forming an extended personal trust network of the member;
means for each member to control to what extent and in what context other members can designate the member as a trustee;
means for each member to specify in what context and to what extent other members who have designated the member as a trustee can use the member's connected personal trust network as an extended personal trust network;
means for ensuring that members of the extended personal trust network can remain anonymous; and
means for each member to provide feedback to adjust that member's personal trust network to enhance accuracy.

6. The trust network system according to claim 5 further comprising means for calculating an effective trust level for a path between each pair of members.

7. The trust network system according to claim 6, wherein said trust level calculations are used to find, share or filter data including ratings, recommendations and opinions.

8. The trust network system according to claim 6, wherein said trust level calculations are used to find or filter electronic messages or communications.

9. An extended personal trust network system containing individual members comprising:
means for each member to designate trustees who are trusted other members, the context of such trust and the degree of such trust, thus forming a personal trust network connected to the member wherein each trustee can also have a connected personal trust network;
means for each member to specify to what extent and in what context the member trusts the personal trust network of each of the member's trustees, the resulting trusted personal trust networks of each trustee thereby forming an extended personal trust network of the member;
means for ensuring that contents of each member's personal trust network remains private and personal and unknown to other members; and
means for each member to provide feedback to adjust that member's personal trust network to enhance accuracy.

10. The trust network system according to claim 9 further comprising means for calculating an effective trust level for a path between each pair of members.

11. The trust network system according to claim 10, wherein said trust level calculations are used to find, share, or filter data including ratings, recommendations and opinions.

12. The trust network system according to claim 11, wherein said trust level calculations are used to find, share, transmit, or filter electronic messages, media, or communications.

13. A personal trust network system containing individual members comprising:
means for each member to designate trustees who are trusted other members, the context of such trust and the degree of such trust, thus forming a personal trust network connected to the member wherein each trustee can also have a connected personal trust network;
means for each member to provide feedback regarding results from use of the trust network system; and
means for each member to control the indirect adjustment of the degree or amount of trust held for one or more other members based upon the member's feedback regarding or related to information, data, or communication derived from use of the trust network system;

14. The trust network system according to claim 13, further comprising means for each member to control the indirect adjustment of the degree or amount of trust held for one or more other members based upon the other members' feedback concerning information, data, or communication derived from use of the trust network system.
